(19) United States
(12) Patent Application Publication
(10) Pub. No.: US 2007/0226940 A1
(43) Pub. Date: Oct. 4, 2007

(54) Connector for Connecting an Arm in the Form of a Segment of a Profiled Element, to an Articulated Structure of a Windscreen Wiper Blade

(75) Inventor: Jean-Claude Thienard, Gisors (FR)

Correspondence Address: OSHA LIANG L.L.P., 1221 MCKINNEY STREET, SUITE 2800, HOUSTON, TX, 77010, US

(73) Assignee: Valeo Systemes d'Essuyage, La Verriere (FR)

(21) Appl. No.: 10/587,885

(22) PCT Filed: Jan. 24, 2005
(86) PCT No.: PCT/EP05/00648

§ 371 Date: Jun. 1, 2007

(30) Foreign Application Priority Data
Jan. 30, 2004 (FR) 0400912

(51) Int. Cl. B60S 1/40

(52) U.S. Cl. 15/250.32

(57) ABSTRACT

The invention relates to a connector (18) for connecting an end (14) of an arm (12) of a windscreen wiper blade (10) to an articulated transversal axle (30) pertaining to a structural element (16) of a wiper blade. Said connector is characterised in that it comprises an upper part (32) that can be connected, in a dismountable manner, to an end (14) of a wiper arm (12) that is generally in the form of a segment of a longitudinal profiled element having an upside-down U-shaped cross-section, and a lower part (34) that can be received, in a dismountable manner, between two parallel wings (24) of a structural element (16) of a windscreen wiper blade, said wings (24) being connected by an upper back (26) and comprising a transversal rod (30) extending between the inner faces (24i) of the two wings (24) in order to form the articulated transversal axle. The inventive connector can be applied to an arm which is adapted in such a way as to be assembled onto a “flat-blade”-type wiper blade.

The present invention relates to a connector making it possible to connect one end of a windshield wiper arm that is initially designed to be connected to a “flat-blade” type wiper blade unit to another wiper blade unit of some other conventional type having a hinged structure.

In a low-height design for a windshield wiper, the hinged structure of the windshield wiper arm that carries the wiper blade proper, i.e. the squeegee or “rubber”, is omitted, and it is, for example, spine members, or structural reinforcement elements analogous to spine members, that are associated with the flexible wiper blade to constitute the wiper blade unit proper, also referred to as a “flat-blade” unit.

The blade unit is hinged to the end of a drive arm in which the structure of the end of the arm and the structure of the hinge means make it possible to reduce the total height of the windshield wiper.

Document WO-A-03 080 409 describes and shows such a windshield wiper that has a wiper blade unit of the flat-blade type, and an associated drive arm.

The free end of the drive arm, which end carries the wiper blade unit, is substantially in the shape of a section member segment having an upside-down channel section which is downwardly open, and which receives a connector.

Since the wiper blade unit is an element that rubs against the windshield of a vehicle, it is an element that is subjected to wear and that must be replaced with a new wiper blade unit after a certain period of use.

However, it can happen that no wiper blade unit of the flat-blade type is available for replacing the worn wiper blade unit, it then being necessary for the owner of the vehicle to assemble a wiper blade unit of the conventional type, i.e. a wiper blade unit that has a hinged structure, to the end of the arm.

Unfortunately, conventional hinged-structure wiper blade units are designed to be assembled to a windshield wiper arm end that is of the type in the form of a U-shaped curved-back hook, or that is of the type in the form of a longitudinal rod of rectangular cross-section, or indeed that is of the type having a transverse pin that extends transversely from a side edge of the end of the arm.

Connectors have been proposed that make it possible to connect a wiper arm end of one of the three above-mentioned types to a wiper unit of conventional structure, but no connector makes it possible to connect a wiper arm end that is designed for a windshield wiper of the flat-blade type to a wiper blade unit of conventional structure.

Therefore, the invention provides a connector for connecting one end of an arm of a windshield wiper to a transverse hinge pin belonging to a structure element of a windshield wiper blade unit:

said connector being characterized in that it comprises a top portion which is suitable for being connected in disassemblable manner to one end of a windshield wiper arm, which end is substantially in the shape of a section member segment having an upside-down channel section which is downwardly open; and a bottom portion which is suitable for being received in disassemblable manner between two parallel flanges of a structure element of a windshield wiper blade unit whose flanges are interconnected via a top back and which is provided with a transverse rod that extends between the inside faces of the two flanges so as to constitute the transverse hinge pin.

According to other characteristics of the invention:

the top back is provided with an orifice for assembling the bottom portion of the connector between the parallel flanges of the structure element of the wiper blade unit;

the bottom portion of the connector has outside vertical guide side faces, each of which bears against a respective facing and adjacent inside vertical longitudinal face of the structure element;

the guide faces are offset longitudinally relative to the hinge axis defined by the hinge pin;

guide side faces are outside faces of guide side flange plates of the bottom portion of the connector, which guide side flange plates are distributed on either side of a vertical longitudinal midplane of the connector;

the bottom portion of the connector is provided with at least one cylindrical hinge recess having a transverse axis and into which said transverse hinge rod is suitable for being inserted radially;

the bottom portion of the connector is provided with a plurality of hinge recesses of different inside diameters, so that the connector can receive complementary transverse hinge rods of different sizes;

the bottom portion of the connector is provided with an opening associated with each recess, which extends vertically downwards from the associated recess, and which opens out in a bottom edge of the bottom portion of the connector;

the hinge recesses are provided in hinge side cheek plates of the bottom portion of the connector, which hinge side cheek plates are distributed on either side of a vertical longitudinal midplane of the connector;

the guide cheek plates and the hinge cheek plates that are situated on the same side of the longitudinal midplane of the connector are portions of a common cheek plate extending vertically downwards from the top portion of the connector;

the top portion of the connector is of shape complementary to the shape of the end of the arm, and the top portion of the connector is provided with means for locking the connector in the position in which it is assembled in the end of the arm;

the connector is provided with longitudinal catches for locking the connector in the position in which it is assembled in the front end of arm, which catches extends longitudinally rearwards from the rear longitudinal end of the top portion of the connector;

the free longitudinal end of each longitudinal catch forms a hook that is suitable for bearing against a rear edge of the end of the arm for locking the connector in rearward and/or downward movement relative to the end of the windshield wiper arm;

the top portion of the connector is extended forwards by a nose which projects vertically upwards relative to a horizontal top face of the top portion of the connector, and which has a rear vertical transverse face against which the end of the arm is in longitudinal abutment forwards when the connector is in the position in which it is assembled in the end of the arm; and

the horizontal top face of the top portion of the connector is provided with an orifice at its front transverse end, which orifice is suitable for receiving a finger on the end of the windshield wiper arm.

Other characteristics and advantages of the invention will appear on reading the following detailed description which, in order to make it easier to understand, is given with reference to the accompanying figures, in which:

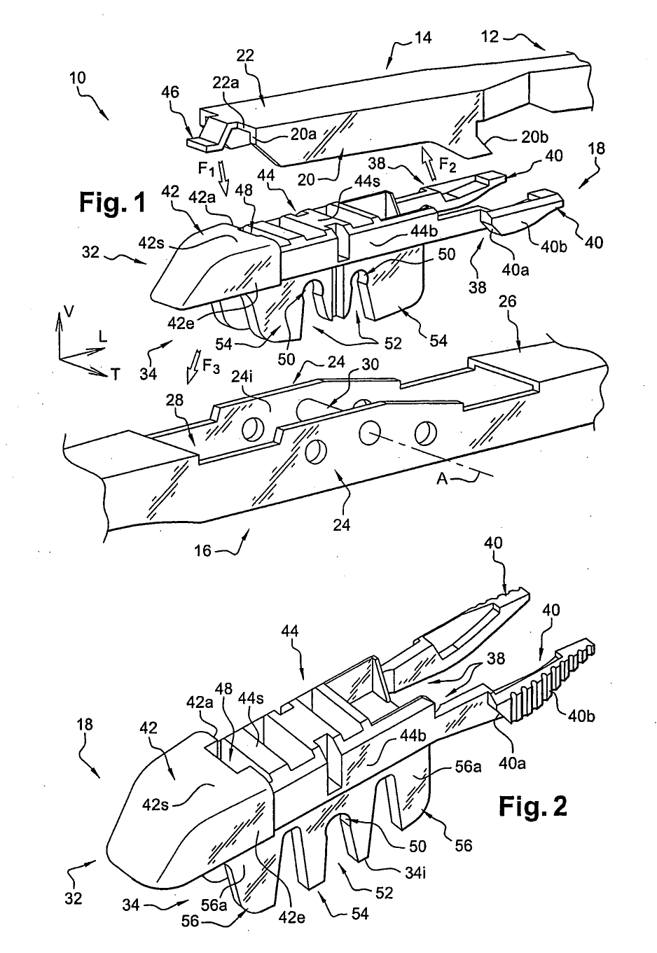

FIG. 1 is a diagrammatic exploded perspective view of a windshield wiper, showing a drive arm for a wiper blade unit of the flat-blade type, which drive am can be connected to a conventional wiper blade unit via a connector of the invention;

FIG. 2 is a perspective view of a variant embodiment of a connector of the invention;

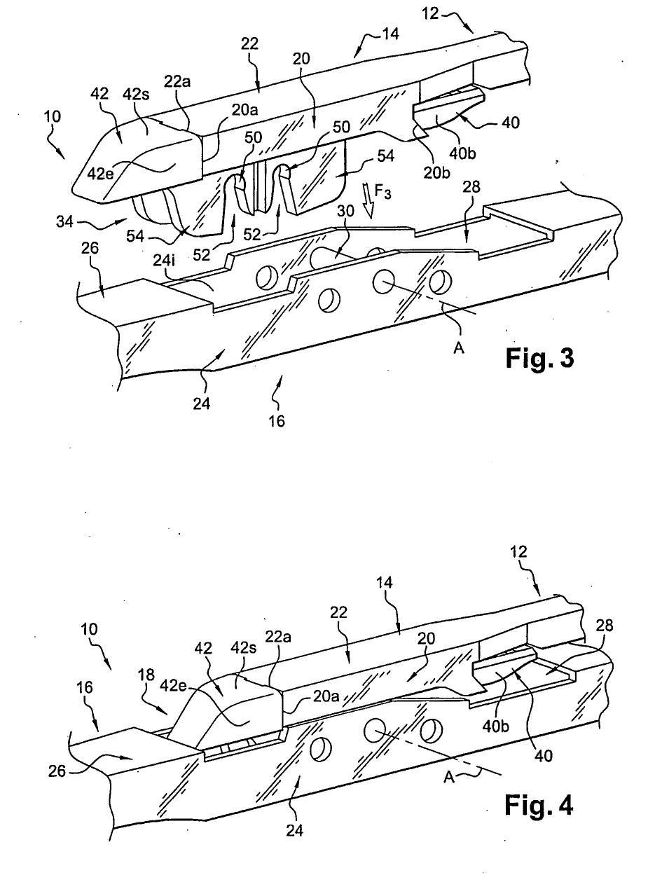

FIG. 3 is a view similar to the FIG. 1 view, and in which the connector is in the position in which it is assembled in the end of the arm;

FIG. 4 is a view similar to the FIG. 3 view and in which the connector, the end of the arm and the windshield wiper blade unit are in the assembled position;

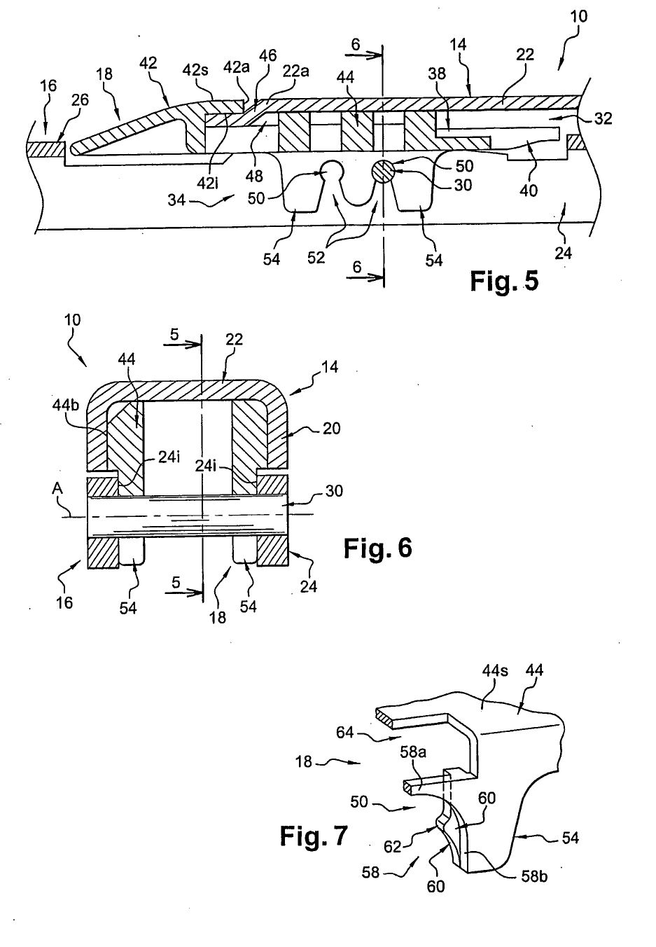

FIG. 5 is a longitudinal section view of the windshield wiper shown in FIG. 6, in section on 5-5;

FIG. 6 is a cross-section view of the windshield wiper shown in FIG. 5, in section on 6-6; and

FIG. 7 is a detail view on a larger scale of the connector shown in FIG. 2, showing a variant embodiment of a hinge recess and of the associated opening.

For the description of the invention, the vertical, longitudinal, and transverse directions are adopted in non-limiting manner, using the frame of reference V, L, T indicated in the figures.

The front-to-rear direction is also adopted as being the longitudinal direction, and from left to right with reference to FIG. 1.

In the description below, elements that are identical, similar or analogous are designated by like references.

The figures show a windshield wiper 10 including a drive arm 12 whose first end is connected to a drive mechanism (not shown) and whose free front end 14 is connected to a main bracket 16 of a windshield wiper blade unit via a connector 18.

The free front end 14 of the drive arm 12 consists of a longitudinal section member segment whose cross-section on a vertical transverse plane is in the shape of an upside-down U, i.e. it is downwardly open.

The end 14 of the arm 12 thus has two parallel side cheeks 20 that extend vertically and longitudinally, and that are interconnected by a horizontal web or “back” 22.

The windshield wiper blade unit is the type having a hinged structure making it possible to press the wiper blade proper (not shown) against the windshield of the vehicle (not shown), so that the wiper blade proper matches the profile of the windshield so as to bear snugly thereagainst.

The main bracket 16 is a component of the hinged structure of the wiper blade unit, and it has two parallel longitudinal flanges 24 that are interconnected via a transverse top back 26.

At its ends, the bracket 16 carries a series of yokes (not shown) that are connected to metal spine members (not shown) for supporting the wiper blade proper (not shown).

In its central portion, the bracket 16 is provided with a top opening 28 formed in its top back 26 and in which a transverse rod 30 is arranged that interconnects the two flanges 24 and that forms a transverse axis A about which the bracket 16 is hinged relative to the end 14 of the arm 12.

The connector 18 makes it possible to connect the end 14 of the arm 12 to the bracket 16.

To this end, and according to the invention, the connector 18 has a top portion 32 which is suitable for being connected in disassemblable manner to the end 14 of the arm 12, and a bottom portion 34 which is suitable for being received in disassemblable manner between the two flanges 24 of the bracket 16.

The top portion 32 of the connector has a central body 44 which is of rectangular block shape complementary to the end 14 of the arm 12, and means for locking the body 44 in the position in which it is assembled in the end 14 of the arm 12.

The locking means comprise longitudinal locking catches 38 that extend longitudinally towards the rear of the body 44.

The free rear longitudinal end 40 of each longitudinal catch 38 forms a transverse hook which extends towards the end of the connector 18, and which is suitable for pressing against a rear edge 20b of the association cheek 20 of the end 14 of the arm 12.

Thus, when the top portion 32 of the connector 18 is in the position in which it is assembled in the end 14 of the arm 12, the longitudinal catches 38 extend between the cheeks 20 of the end 14 of the arm 12, except for their respective free ends 40 which project transversely outwards and rearwards from the cheeks 20.

In a preferred embodiment, the free rear end 40 of each locking catch 38 has a front face 40a for bearing against the rear edge 20b of the associated cheek 20.

The rear edge 20b of the cheek 20 and the front face 40a slope downwards, so that the locking catches 38 simultaneously lock the connector 18 in downward movement and in forward movement relative to the end 14 of the arm 12.

The top portion 32 of the connector 18 also has a nose 42 that extends the body 44 forwards.

The nose 42 is shaped so that it projects vertically upwards relative to a top face 44s of the body 44, and so that it projects transversely relative to the vertical longitudinal side faces 44b of the body 44.

The nose 42 thus has a rear vertical transverse face 42a which bears against respective ones of the front transverse or vertical edges 22a, 20a of the back 22 or of the cheeks 20 of the end 14 of the arm 12, when the connector 18 is in the position in which it is assembled in the end 14 of the arm 12.

As can be seen in FIG. 3, the nose 42 is shaped so that its outside top face 42s and its outside side faces 42e are flush with the cheeks 20 and with the back 22 of the end 14 of the arm 12, when the connector 18 is in the position in which it is assembled in the end 14 of the arm 12.

The nose 42 thus extends in alignment with the end 14 of the arm 12, thereby making it possible to impart improved aerodynamic properties, and a pleasing appearance to the windshield wiper 10.

The front portion of the top portion 32 is locked in vertical movement relative to the end 14 of the arm 12 by a finger 46 carried by the end 14 of the arm 12, which finger extends downwards and forwards from the front edge 22a of the back 22.

The top face 44s of the body 44 is provided with an orifice 48 in the vicinity of its front end, in which orifice the finger 46 is received when the connector 18 is in the position in which it is assembled in the end 14 of the arm 12, so that the finger 46 bears upwards against a bottom face 42i of the nose 42.

The connector 18 is assembled in the end 14 of the arm 12, in a first movement, by inserting the finger 46 into the orifice 48 in the body 44, as shown in FIG. 1 by arrow F1.

Then, in a second movement, the body 44 is inserted between the cheeks 20 of the end 14 of the arm 12.

So that the ends 40 of the catches 28 do not oppose said second movement, the user who is performing the assembly, presses on the outside side faces 40b of the ends 40 in a manner such as to cause the catches 38 to deform elastically, said catches then retracting between the cheeks 20.

Finally, when the connector 18 is in the position in which it is assembled in the end 14 of the arm 12, the user relaxes the pressure applied to the ends 40, so that the catches 38 return resiliently to their initial position in which the front faces 40a of their ends are bearing against the rear edges 20b of the cheeks 20, as shown in FIG. 3.

As mentioned above, the bottom potion 34 of the connector is suitable for being received between the two flanges 24 of the bracket 16, through the opening 28 in the top back 26 of the bracket 16.

The bottom portion 34 also forms the hinge via which the connector 18 is hinged relative to the windshield wiper blade unit about the transverse axis A. To this end, the bottom portion 34 is provided with a transverse cylindrical hinge recess 50 which is suitable for receiving the transverse rod 30.

The bottom portion 34 is further provided with an opening 52 which extends vertically downwards from the hinge recess 50, and which opens out in the bottom edge 34i of the bottom portion 34.

The opening 52 makes it possible to insert the transverse rod 30 radially into the hinge recess 50, while the bottom portion 34 is being assembled between the flanges 24 of the bracket 16.

In addition, the opening 52 and the hinge recess 50 hold the bottom portion 34 in position around the hinge rod 30.

For this purpose, the dimensions of the opening 52 are determined so as to form a narrow portion or “throat” where the opening 52 meets the hinge recess 50.

In a preferred embodiment of the connector 18, making it possible to reduce the quantity of material necessary for making it, the bottom portion is a substantially hollow element.

The hinge recess 50 is then provided in vertical longitudinal hinge cheek plates 54 which are distributed transversely on either side of a vertical longitudinal midplane of the connector 18.

There exist a wide variety of sizes of windshield wiper blade units of the type having hinged structures. Therefore, the dimensions of certain elements of the wiper blade unit vary depending on the sizes.

This applies in particular as regards the diameter of the transverse rods 30.

In order to be assembled in different sizes of wiper blade unit, and in a variant embodiment of the invention shown in FIGS. 1 and 3, the bottom portion 34 of the connector 18 is provided with a plurality of hinge recesses 50, of different inside diameters, each associated with a particular size of transverse rod 30.

To this end, the hinge cheek plates 54 are provided with a plurality of openings 52, each associated with a particular hinge recess 50.

When the bottom portion 34 is in the position in which it is assembled between the flanges 24 of the bracket 16, it is also hinged relative to the bracket 16 about the axis A.

FIG. 2 shows a variant embodiment of a connector 18 of the invention, in which the bottom portion 34 is provided with cheek plates 56 which contribute to guiding the bottom portion 34 as it pivots relative to the bracket 16.

Each of said guide cheek plates 56 has an outside vertical guide side face 56a which bears against the facing inside longitudinal face 24i of a flange 24 of the bracket 16.

In a preferred embodiment of the invention, the guide faces 56a are offset longitudinally relative to the axis A, at a distance from the axis A that is as large as possible, in view of the general dimensional characteristics of the brackets 16, thereby making it possible to procure guiding that is as effective as possible.

In a variant embodiment of the invention shown in FIG. 2, the guide cheek plates 56 and the hinge cheek plates 54 which carry hinge recesses 50 are cheek plates that are distinct from the bottom portion 34 of the connector 18.

However, it should be understood that the guide cheek plates 56 that are arranged on the same side of the vertical midplane of the connector and the hinge cheek plates 54 that are arranged on the same side of the vertical midplane can be portions of a common cheek plate that extends vertically downwards from the body 44 of the top portion 32 of the connector 18.

The bottom portion 34 of the connector 18 is assembled in the opening 28 in the bracket 16 by means of a substantially vertical and downward movement of the connector 18 relative to the bracket 16, as shown by the arrow F3 in FIG. 3, by inserting the rod 30 into the opening 52, and then by exerting a vertical force downwards on the connector, in a manner such as to insert the rod 30 into the hinge recess 50.

The guide faces 56a are then outside faces of the common cheek plate that is designated below by the reference 54 of the hinge cheek plates.

As can be seen in FIGS. 4 and 6, when the connector 18 connects the end 14 of the arm 12 to the bracket 16, the top portion 22 of the connector 18 extends above the flanges 24 of the bracket 16.

The same applies for the end 14 of the arm 12 for which the bottom edges of the cheeks 20 extend vertically above the flanges 24 of the bracket 16.

This enables the connector 18 and the end 14 of the arm 12 to pivot relative to the bracket 16, about the transverse axis A, without the flanges 24 hindering their movement.

The connector 18 of the invention is made in one piece and of molded plastics material, and, for this purpose, in a known mode of operation, use is made of complementary top and bottom molds.

Unfortunately, certain shapes of the connector 18, and more particularly the throats formed where the hinge recesses 50 meet the associated openings 52, make it necessary for the connector 18 to have upward and downward disengagement paths, which is not possible because of the presence of the top end wall of the hinge recess 50.

In order to enable the throats to be formed, and in a variant embodiment of the connector shown in FIG. 7, the hinge recess 50 is defined in its top portion by an opening 58 that is substantially in the shape of an upside-down U, which is formed in the cheek plate of the bottom portion of the connector.

The arched end wall 58a of the opening 58 forms a semi-circle, and defines the top portion of the hinge recess 50. The edges 58b of the opening 58 are rectilinear, in a manner such they do not make it possible for the rod 30 to be locked in the hinge recess 50.

The opening 58 extends upwards from the bottom edge of the associated hinge cheek plate 54, and it also forms the opening 52 via which the rod 30 is inserted into the hinge recess 50.

For defining the bottom portion of the hinge recess 50, and thus for forming the means for vertically locking the rod 30 in position in the hinge recess 50, the hinge cheek plate 54 carries pieces of extra thickness 60 on its inside face, each piece of extra thickness being associated with a respective 58b of the opening 58.

Each piece of extra thickness 60 comprises a lug 62 which projects longitudinally towards the inside of the opening 58 relative to the corresponding edge 58b of the opening 58.

The association of two mutually facing lugs 62 makes it possible to form the throat necessary for vertically locking the rod 30 in the position in which it is assembled in the hinge recess 50, and thus, said lugs 62 define the bottom portion of the hinge recess 50.

The top portion 32 of the connector 18 is further provided with an opening 64 making it possible for a mold element (not shown) to go past the lugs 62.

When the connector 18 is in the position in which it is assembled with a front end 14 of the arm 12 and with the bracket 16 of the wiper blade unit, the connector 18 makes it possible to procure a hinged coupling via which the front end 14 of the arm 12 is hinged relative to the bracket 16 of the wiper blade unit.

However, when the wiper blade unit in turn becomes worn, it is necessary to change it. To this end, and in another advantage of the invention, the connector 18 is assembled with the front end 14 of the arm 12 and with the bracket 16 of the wiper blade unit in disassemblable manner.

This enables the user to use the connector 18 when the replacement wiper blade unit is, once again, a wiper blade unit having a hinged structure, or indeed not to use the connector 18 when the replacement wiper blade unit is of the flat-blade type.

The connector is disassembled from the front end 14 of the arm 12 or from the bracket 16 of the wiper blade unit in the reverse manner relative to the manner in which assembly is performed.

Thus, the connector 18 is disassembled from the bracket 16 by exerting two mutually opposing forces.

The connector 18 is disassembled from the end 14 of the arm 12 firstly by acting on the longitudinal catches 38, in a manner such as to move their ends 40 towards each other, then by disengaging the body 44 of the end 14 from the arm 12, and finally, by removing the finger 46 from the orifice 48 of the body 44.

1. A connector for connecting one end of an arm of a windshield wiper to a transverse hinge pin belonging to a structure element of a windshield wiper blade unit:
said connector being characterized in that it comprises a top portion which is suitable for being connected in disassemblable manner to one end of a windshield wiper arm, which end is substantially in the shape of a section member segment having an upside-down channel section which is downwardly open; and
a bottom portion which is suitable for being received in disassemblable manner between two parallel flanges of a structure element of a windshield wiper blade unit whose flanges are interconnected via a top back and which is provided with a transverse rod that extends between the inside faces of the two flanges so as to constitute the transverse hinge pin.

2. A connector according to claim 1, characterized in that the bottom portion of the connector is suitable for being assembled between the parallel flanges of the structure element of the wiper blade unit, through an opening in the top back.

3. A connector according to claim 1, characterized in that the bottom portion of the connector has outside vertical guide side faces, each of which bears against a respective inside vertical longitudinal face, facing and being adjacent to the flange of the structure element.

4. A connector according to claim 3, characterized in that the guide faces are offset longitudinally relative to the hinge axis defined by the hinge pin.

5. A connector according to claim 3, characterized in that the guide side faces are outside faces of guide side flange plates of the bottom portion of the connector, which guide side flange plates are distributed on either side of a vertical longitudinal midplane of the connector.

6. A connector according to claim 1, characterized in that the bottom portion of the connector is provided with at least one cylindrical hinge recess having a transverse axis and into which said transverse hinge rod is suitable for being inserted radially.

7. A connector according to claim 6, characterized in that the bottom portion of the connector is provided with a plurality of hinge recesses of different inside diameters, so that the connector can receive complementary transverse hinge rods of different sizes.

8. A connector according to claim 6 characterized in that the bottom portion of the connector is provided with an opening associated with each recess, which extends vertically downwards from the associated recess, and which opens out in a bottom edge of the bottom portion of the connector.

9. A connector according to claim 6, characterized in that the hinge recesses are provided in hinge side check plates of the bottom portion of the connector, which hinge side cheek plates are distributed on either side of a vertical longitudinal midplane of the connector.

10. A connector according to claim 20, characterized in that the guide cheek plates and the hinge cheek plates that are situated on the same side of the longitudinal midplane of the connector are portions of a common cheek plate extending vertically downwards from the top portion of the connector.

11. A connector according to claim 1, characterized in that the top portion of the connector is of shape complementary to the shape of the end of the arm, and the top portion of the connector is provided with means for locking the connector in the position in which it is assembled in the end of the arm.

12. A connector according to claim 11, characterized in that the connector is provided with longitudinal caches for locking the connector in the position in which it is assembled in the front end of arm, which catches extends longitudinally rearwards from the rear longitudinal end of the top portion of the connector.

13. A connector according to claim 12, characterized in that the free longitudinal end of each longitudinal catch forms a hook that is suitable for bearing against a rear edge of the end of the arm for locking the connector in rearward and/or downward movement relative to the end of the widshield wiper arm.

14. A connector according to 11, characterized in that the top portion of the connector is extended forwards by a nose which projects vertically upwards relative to a horizontal top face of the top portion of the connector, and which has a rear vertical transverse face against which the end of the arm is in longitudinal abutment forwards when the connector is in the position in which it is assembled in the end of the arm.

15. A connector according to claim 14, characterized in that the horizontal top face of the top portion of the connector is provided with an orifice at its front end, which orifice is suitable for receiving a finger on the end of the windshield wiper arm.

16. A connector according to claim 2, characterized in that the bottom portion of the connector has outside vertical guide side faces, each of which bears against a respective inside vertical longitudinal face, facing and being adjacent to the flange of the structure element.

17. A connector according to claim 4, characterized in that the guide side faces are outside faces of guide side flange plates of the bottom portion of the connector, which guide side flange plates are distributed on either side of a vertical longitudinal midplane of the connector.

18. A connector according to claim 2, characterized in that the bottom portion of the connector is provided with at least one cylindrical hinge recess having a transverse axis and into which said transverse hinge rod is suitable for being inserted radially.

19. A connector according to claim 3, characterized in that the bottom portion of the connector is provided with at least one cylindrical hinge recess having a transverse axis and into which said transverse hinge rod is suitable for being inserted radially.

20. A connector(s) according to claim 4, characterized in that:
the bottom portion of the connector is provided with at least one cylindrical hinge recess having a transverse axis and into which said transverse hinge rod is suitable for being inserted radially; and,
the hinge recesses are provided in hinge side cheek plates of the bottom portion of the connector, which hinge side cheek plates are distributed on either side of a vertical longitudinal midplane of the connector.
